(19) United States
(12) Patent Application Publication
(10) Pub. No.: US 2024/0232562 A1
(43) Pub. Date: Jul. 11, 2024

(54) METHOD AND APPARATUS FOR USING A SINGLE QR CODE TO PROVIDE VARYING USER EXPERIENCES

(71) Applicant: ACTV8, INC., Chatsworth, CA (US)

(72) Inventor: Brian Shuster, Las Vegas, NV (US)

(21) Appl. No.: 18/610,976

(22) Filed: Mar. 20, 2024

Related U.S. Application Data
(63) Continuation-in-part of application No. 17/576,053, filed on Jan. 14, 2022.
(60) Provisional application No. 63/181,653, filed on Apr. 29, 2021.
(60) Provisional application No. 63/263,794, filed on Nov. 9, 2021.

(51) Int. Cl. G06K 19/06; G06F 16/955

(52) U.S. Cl. CPC G06K 19/06037; G06F 16/9554

(57) ABSTRACT

A method for sequential delivery of content triggered after scanning a sequential QR code. A UUID is retrieved from the device based on a request received from the device. A trigger ID is retrieved from the device based on the request received from the device to fetch a previously created trigger configuration which includes a delivery setting. A content list is created based on target matches with the fetched trigger configuration. If a selected one of the content items has been previously delivered to the device, a next one of the content items which has not been selected is delivered to the device for display and the content list is updated to indicate delivery of the selected or next content item to the device. In an embodiment, the number of times a particular QR code is scanned by a user is tracked and used to deliver content.

### BACKGROUND OF THE INVENTION

Barcodes and QR (Quick Response) codes are computer readable images for storing information which can be scanned by a scanning device and converted by a computer into data readable by a human. A barcode is scanned in one direction, while a QR code can be thought of a two-dimensional barcode. QR codes can include more information than barcodes and for this reason can be used in many situations where a barcode cannot be used due to the limited amount of data which can be included in a barcode.

Like barcodes, QR codes can be scanned using special purpose scanners or by the camera in a smartphone which can both detect and scan a QR code. QR codes are generated using a QR code generator as is well known in the art.

Applications for QR codes are almost unlimited, but are frequently used in advertising, business, health care, and education. QR codes can be found in brochures, flyers, posters, billboards, product packaging, business cards, and websites such as social media and shopping sites.

There are two types of QR codes: static and dynamic.

Static QR codes are QR codes that are permanently encoded with information that does not change. This type of QR code is static meaning the data encoded within the QR code will always produce the same result when scanned. Static QR code uses include email addresses, URLs, text, and WiFi passwords. That is, it is a single purpose QR code. The amount of data that can be encoded is limited. If too much data is encoded, scanning it will be less reliable since as the amount of data to be encoded increases, the denser the resulting QR code. As density increases, the more difficult it becomes to be properly scanned. Since the encoded data is the same as the data desired to be presented to a user, it can be used at any time in any location without access to any network.

As shown in FIG. 1, upon scanning a QR code (typically, using a camera built into a mobile device such as a cell phone), the decoded value may be a URL used to open a website. Each time the QR code is scanned, the same URL is used to open the same web page. Instead of a URL, the decoded value could launch a native app on the mobile device, but again, a subsequent scan will launch the same native app. However, when the QR codes decodes a URL, the only information provided to a website accessed by the decoded URL is the address of device which made the request and possibly information about the browser on the device so that the delivered content can be properly rendered on the device.

Dynamic QR codes are QR codes that store a short URL. When scanned, the linked data associated with the URL is retrieved and whatever action is desired when the link is selected will take place. That is, just as a link on a web page, when selected within a web browser, will produce some action, similarly, the link associated with the URL encoded by the QR code will be activated and any information at that link is transmitted to the device that sent the request after the QR code was scanned. For this reason, when a device scans a dynamic QR code, it must be connected to a network which can access the link associated with the URL obtained by scanning the QR code.

Since a dynamic QR code when scanned links to is embedded URL, it is a simple matter to set up that URL so that it redirects to another URL as a function of additional information provided by the device accessing the URL. The additional information can be the browser being used by the device, the device operating system, the device type, e.g. mobile phone or tablet. The redirected URL can then be set up to provide data in the best form for that device type and browser. Although dynamic QR codes provide more flexibility than static QR codes, they cannot be used to tailor to content to specific end user devices. Additionally, like a static QR code, the only information provided to a website accessed by the decoded URL is the address of device which made the request and possibly information about the browser on the device so that the delivered content can be properly rendered on the device.

Thus, static QR codes and dynamic QR codes are similar in that the embedded value is a static value such as a URL. For example, an admin creates a QR code with a value of a URL “http://www.example1.com/abcdef”. Any end-user device that scans the code will be sent to that web address. However, in the case of a static QR code, the end-user will ALWAYS land on the http://www.example1.com/abcdef website. In the case of the dynamic QR code, an admin can setup a redirection at a later to another website such as “http://www.example2.com”. In this case, any end-user that scans the dynamic QR code will first land at the “http://www.example1.com/abcdef” site and then be redirected to http://www.example2.com.

The invention overcomes these limitation as described below.

### SUMMARY OF THE INVENTION

The invention uses what can be referred as a sequential QR code or SQR code. Each time a SQR code is scanned (using a camera built into a mobile device such as a cell phone), a different user experience is obtained based on the sequential configuration and trigger settings. Although the SQR code is configured as a static QR code, its implementation as a SQR code enables many if not all of the advantages of a dynamic QR code. Although the data encoded in a SQR code is a URL, and, therefore, always links to the sane webpage, additional data provided by the device used to scan the SQR code enables additional actions to be taken.

Unlike the prior art, in the case of the SQR (sequential QR code), upon scanning, the end-user device will land on the http://www.example1.com/abcdef as in the prior art. However, a web app (website) or client device API presents a custom experience to the end-user based on targeting settings configured by an admin. This means, it is a static QR code with a dynamic web experience based on the uniqueness of the user (device UUID) accessing it and other information provided in addition to a URL and information about the browser on the device.

### BRIEF DESCRIPTION OF THE DRAWINGS

FIG. 1 is shows how a prior art QR code is used.

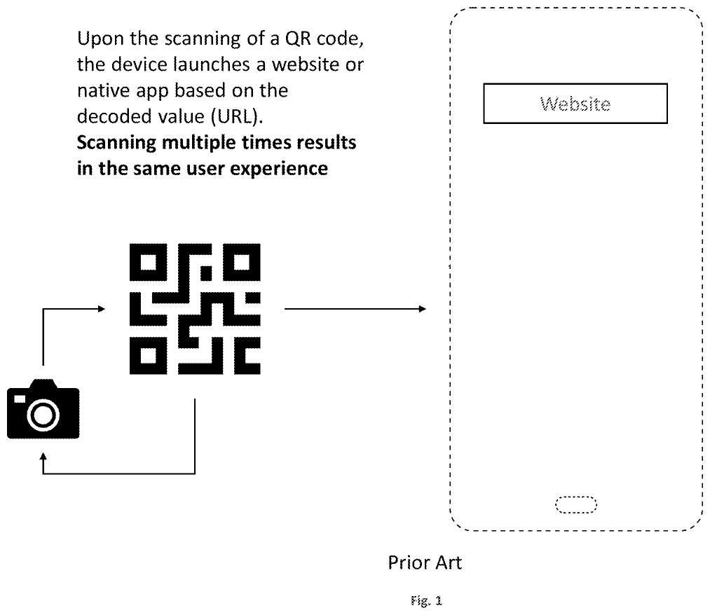

FIG. 2 shows how the invented SQR code is used.

FIG. 3 is an overview block diagram showing the process flow when an SQR code is scanned.

FIG. 4 is block overview diagram showing the process flow for creating a campaign which uses SCR codes.

FIG. 5 is a detailed block diagram showing the process flow when an SQR code is scanned.

FIG. 6 is a flow diagram showing the processing performed by a backend server when handling a request resulting from a scanned SQR code.

FIG. 7 is a flow diagram showing the processing performed in an alternate embodiment by a backend server when handling a request resulting from a scanned SQR code.

### DETAILED DESCRIPTION OF THE INVENTION

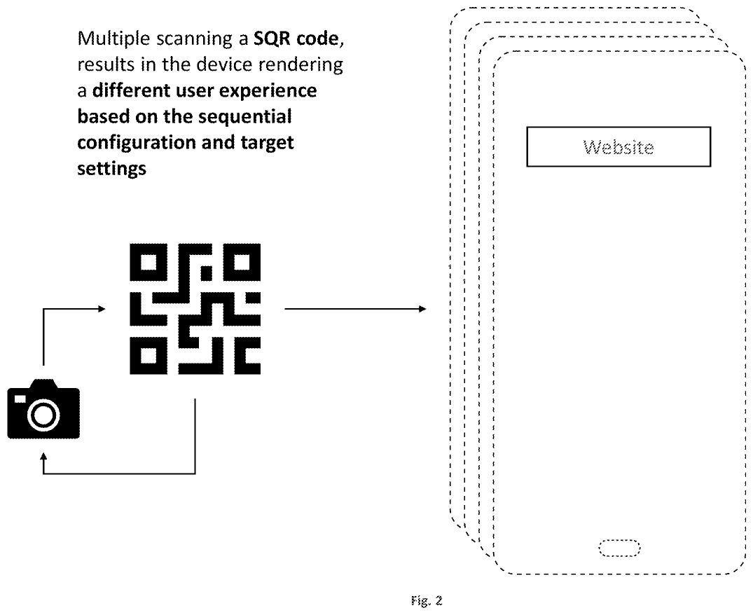

As shown in FIG. 2, each time an SQR code is scanned, although the code resolves to a URL for a particular web page, a different user experience is obtained based on the sequential configuration and target settings. In this connection, the sequential configuration is the order in which content is delivered by the backend server to an API client upon request. The target settings are the parameters (i.e., device location, operating system, user demographics, date/time, day of week) that determine which content item should be delivered by the backend server to the API client.

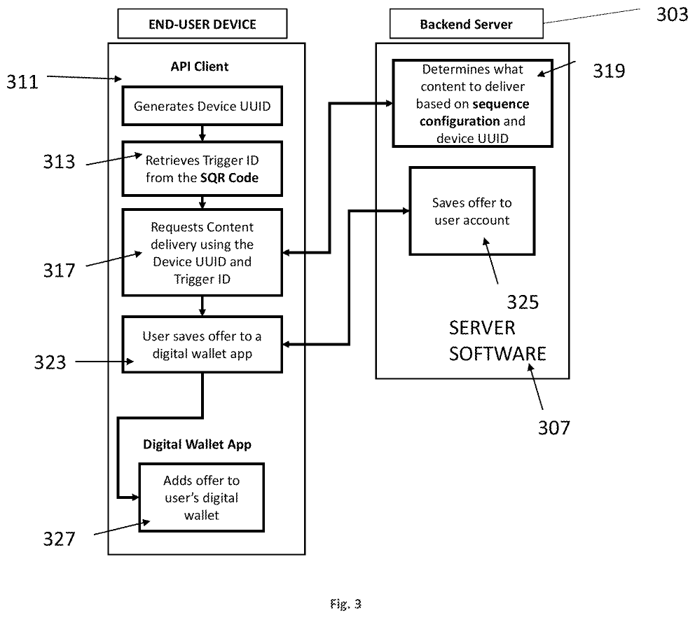

FIG. 3 shows the main functional blocks of the process flow for the delivery of sequential offers using SQR codes. An end user device 301 communicates with a backend server 303 running server software 307 which controls the server operation and accesses a database on the server which maintains all relevant information. Of course, the database can consist of multiple files which store information, the specifics of which are well known in the art and not needed for a proper understanding of the invention. The end user device has an API client 305 which may be a native app or web application which generates 311 a UUID for the device where the API client is hosted. In either case, that is, whether an API running on the client device or an API running in conjunction with a web application, the flow as shown in FIG. 3 is essentially the same. The UUID is a unique device ID based on parameters obtained from the browser and http request made by the device. The parameters obtained from the browser and http request are, by way of example, as follows: operating system, device model, device locale, IP address, approximate geolocation, screen size. In general, the parameters are made available by the operating system to the native app (including web browsers); they are not used for user identification.

The API client retrieves 313 the trigger ID (unique identifier value for the trigger) from the value decoded from the SQR Code. The identifier value decoded from the SQR code is usually just a URL. However, other possibilities include an app which can be accessed and executed on the device. The decoded value of the QR Code may be a “deep link”, which is a link that is used to launch an-in-app experience (non-web based). In either case, the API client is always a native app (including web browsers) that interacts with the back end server to request content on behalf of an end-user.

The API client requests 317 content from the backend server 303 using the trigger ID and device UUID as part of the request sent to the backend server. The content is simply content which exists on the backend server intended to be provided when requested by a client. Examples of such content include redeemable offers, calendar reminders, quizzes, messages, URL redirects, prizes.

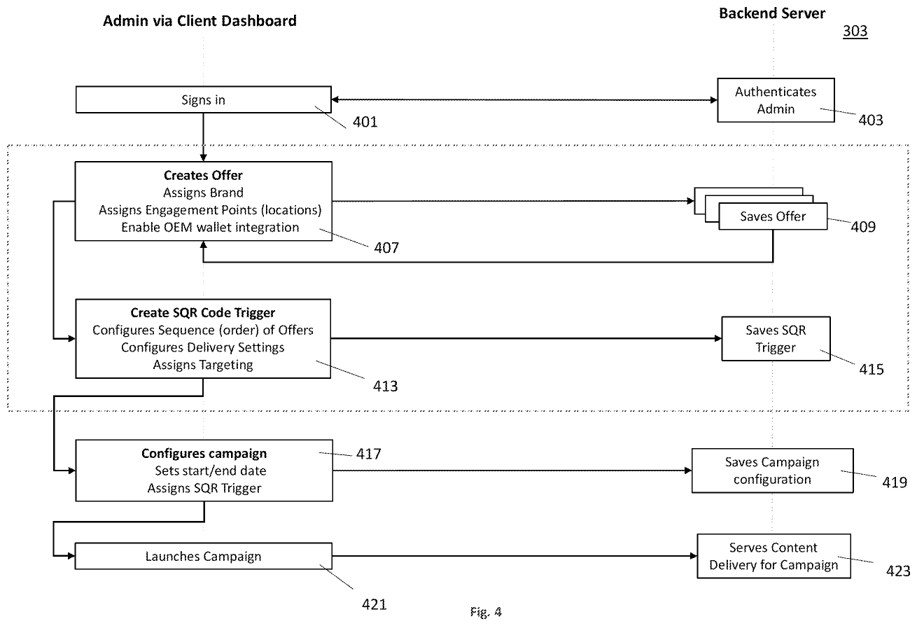

The backend server uses the provided trigger ID and UUID to retrieve the trigger configuration, including the content sequence, and based on targeting and sequence parameters determines 319 which content item to send back to the API client. The content sequence normally includes an offer associated with the content such as a discount on the price of an item from a retail brand and also includes the redemption information and terms of use. The targeting parameters include time of day, location, device OS or any other parameter which is desired to be considered relevant to each offer. Further details are set forth below with reference to FIG. 4. The sequence parameters include the order in which the content should be delivered, the enabling or disabling of the content redelivery, the limit on the number of offers that should be delivered during a defined period of time (e.g., three pieces of content during a 24-hour period). The determination of which content item to send is made based on the sequence configuration and device UUID as follows. Upon receiving a content delivery request from an API client, the backend server retrieves the trigger configuration from the parameters sent on the request and creates a collection of all the available content that match the device parameters (e.g., geolocation, OS name, time of day, etc.). The backend loops through the sequence of content until it finds an item that has not yet been delivered to the device with such UUID. When it does, it makes it available to the API client as a server response.

The API client renders the content view using the content item such as an offer returned from the backend server and allows the user to save 323 the content to a digital wallet native app 327. A typical content view includes content brand, content title, content description, content main image, content secondary image, redemption code, redemption instructions, terms of use. The content is also saved 325 to a user account established on backend server 303.

The manner in which the API client renders the content view depends on the specifics of the content. The specific details of how the content is presented are not important to an understanding of the invention, and are generally well known in the art.

The digital wallet app 327 (e.g., Google® Pay, Apple® Pay, custom wallet, etc.) handles the saving of the content as well known in the art by adding the content to the digital wallet. The specific mechanisms employed are handled by the digital wallet app itself. The API client simply passes the content details to the digital wallet app on the end-user device.

FIG. 4 highlights the main functional blocks of the process flow for the setting up of a campaign that delivers content in a sequential manner: An admin user provides credentials and signs in 401 to a client dashboard (control panel, content management system). The client dashboard is an interface running on the backend server 303 presented to an admin user who provides a user name, password and possibly other information to authenticate the admin user and provide authorization to enter certain specific information based on the specifics of a current campaign.

The backend server authenticates 403 the user using the provided credentials.

Admin user creates 407 the content such as an offer to be delivered by brand, engagement points, as well as other offer parameters. Also, native wallet integration is enabled at this stage.

The assigned brand is simply the product or products which form the offer which is the subject of the campaign. Engagement points are assigned using criteria such as the location of the retail stores relevant to the content that is delivered (i.e. the location of a retail store where an offer can be redeemed). Other offer parameters include content brand, content title, content description, content main image, content secondary image, redemption code, redemption instructions, terms of use. Native wallet integration is enabled as follows: as part of the content configuration, the admin user is given the option (via a checkmark) to instruct the backend server to generate a native wallet pass that is made available to the API client for the insertion of the content into the native wallet application (i.e. Apple Pay, Google Pay) installed on the end-user device.

After the admin user has completed all elements which form the content such as offers to be presented to end-users, the specifics are saved 409 on the backend server 303.

The admin user repeats this process until the desired number of offers or other content are configured on the backend server. As many offers or other content as desired can be created and saved by repeating the preceding steps for each offer. That is, all offers which are to be sequentially delivered are created and saved.

Admin user creates 413 a SQR code trigger as follows. The sequence of offers or other content created in block 407 is specified. For example, assume that three offers have been created. The three offers can be presented in any order desired. That is, no matter when an offer has been created. It can be presented before or after any other offer, as desired. Delivery settings are configured as delivery mode settings such as Delivery mode=Sequential or Random or Multiple. Sequential means that offers are delivered sequentially in a specified order. Random means that offers are delivered in a random order. Multiple delivery mode means that upon request, the backend server will respond with more than one content item based on the preconfigured target settings.

The admin user assigns any other targeting parameters such as time of day, location, device OS to be used as an SQR trigger

The following table illustrates one possible campaign scenario:

### Campaign Details

Name: XYZ January 2022
Start Date: Jan. 1, 2022
End Date: Jan. 31, 2022

### Content Details

```
Content #1
  Type: Offer
  Title: Save 15% on ABC cleaning products
  Brand:
    Name: SQR Cleaning
    Points of interest:
      - 224 Hardware St, Computer City, XY 112235
      - 777 Screen Dr, Computer City, XY 112234
  Description: Start the year with savings of 15% on all SQR cleaning products
  Image: [JPEG file]
  Redemption code: 1234567890
  Enable Native Wallet: FALSE
Content #2
  Type: Offer
  Title: Free drink when you order a Large Cheese Pizza
  Brand:
    Name: SQR Pizza
    Point of interest:
      - 123 Test Dr, Computer City, XY 112233
      - 456 Circuit Rd, Computer City, XY 112234
  Description: Get 1 free drink when you order a Large Cheese Pizza from SQR
  Image: [JPEG file]
  Redemption code: 5678901234
  Enable Native Wallet: TRUE
```

Other types besides offer include Message, Redirect, Prize, Question, URL.

The Brand Name is the trademark for a product or retail store name or other similar identifier. The Brand Point of Interest represent a geographical location (latitude/longitude) relevant a specific brand. For example: the location of a Walmart retail store in Los Angeles, CA where an offer for the brand Coke can be redeemed.

The Image is simply a picture of the product, retail store logo, etc. The Redemption code is the code the user uses to exercise the offer or other type of content. Enable Native Wallet is a flag which specifies whether or not the offer or other type of content can be stored in a digital wallet app on the user's mobile device.

### Trigger Details

Trigger Type: Sequential QR Code (SQR)
Precise Location: FALSE (use approximate location)

### Delivery Settings

```
Content Redelivery: Enabled
Group 1:
  Schedule: Every day
  Target:
    Region: California
    Operating System: Android, iOS
  Content:
    Content #1
    Content #2
```

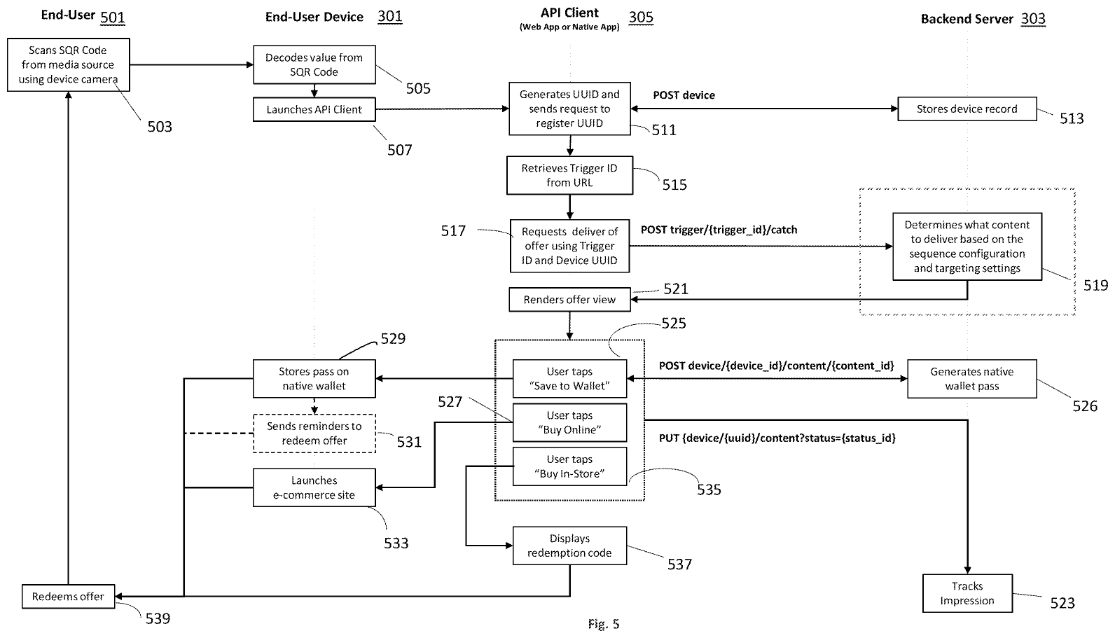

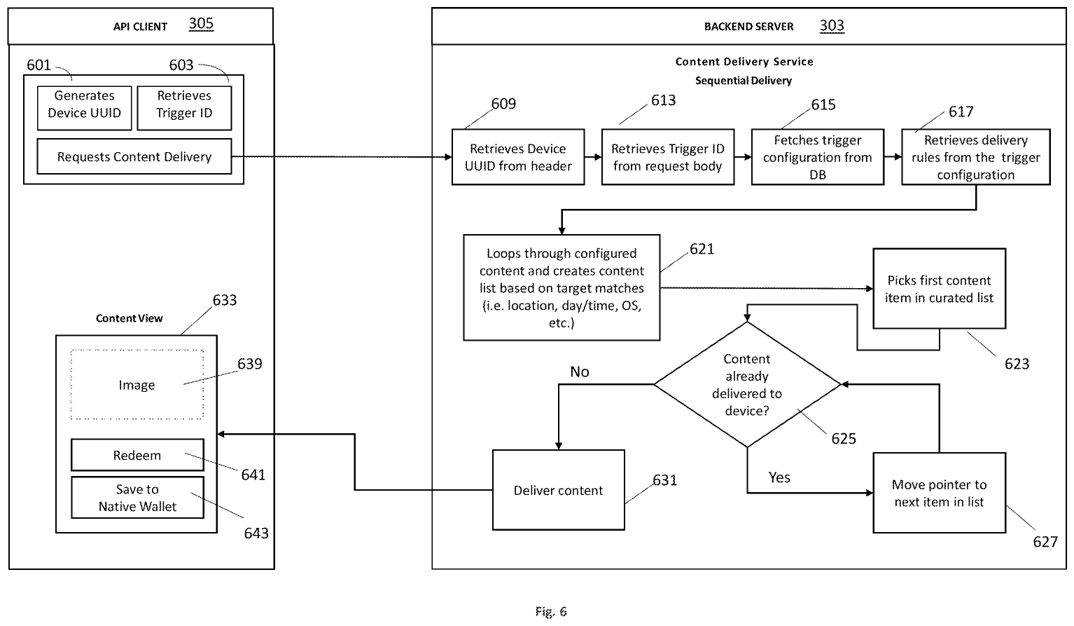

Trigger types other than SQR include Media Trigger, Hyperlink Trigger, Audio Trigger, Beacon Trigger, and Geofence Trigger. If Precise location is TRUE, then for the trigger to operate, the location of the device as provided by the device when the request for content delivery is made as described below with reference to FIGS. 5 and 6 must correspond to a valid latitude/longitude value pair that represents a precise geo-location. In this case, content will be delivered based on that geo-location meaning the same SQR code can be used to deliver different content based on the geo-location of the device used to scan the SQR code. If Precise location is FALSE, then the trigger will operate so long as an IP address can be retrieved from the API client request. As to Delivery Settings, Content Redelivery Enabled means that the backend server will continue to deliver the same piece of content multiple times, even if the end-user has previously interacted with the content (i.e. viewed, saved, redeemed, etc.) and Disabled means that the backend server will deliver the piece of content only once, even if the end-user has not interacted with it. The various Group 1 settings have the following meanings:
1. Schedule: the specific date, day of week and time where a specific content should be delivered to API clients. For example: From Jan. 1, 2022 to Jan. 31, 2022, on Mondays from 6pm to 7pm PST
2. Target:
a. Region: the geographical region (i.e. state) that the API client must make the request from so that a specific piece of content can get delivered. For example: “California”
b. Operating System: the name of the operating system that an API client must be installed so that a specific piece of content can get delivered to the end-user.
3. Content: a list of content items that share the same delivery parameters (schedule, target)

Backend server saves 415 the SQR trigger and its configuration. The SQR trigger and its configuration are stored so that they can be easily retrieved when a request is received from a user device after scanning an SQR code which causes the trigger to be sent to the backend server for handling when the trigger is received.

The admin user then configures 417 the campaign by setting the start date and end date and assigns an SQR trigger. As noted above an SQR trigger can be configured to request precise location data from the device. By default, an approximate location is used by retrieving the metadata based on the IP address associated with the API client.

The backend server saves 419 the campaign configuration. The stored SQR trigger and its configuration and the saved campaign configuration are linked together on the server. They are separated and associated with a link so that, for example, a stored SQR trigger and its configuration can be reused with a different start and end date.

The admin user then launches 421 the campaign by moving all of the related stored data so that it is active and responds to requests from end user devices. That is, the backend server serves content upon request for content delivery from API client(s) based on the previously set start and end dates.

FIG. 5 provides a system level view of the process flow that involves the delivery of an offer, from the scanning of a SQR code to the redemption of the offer:

Using the camera of end user device 301 such as a mobile device (i.e. smart phone), an end user 501 scans 503 the SQR code from a media source. The media source can be a digital medium such as a digital screen, smart TV, digital billboard, and the like as well as physical medium such as a poster, sticker, stamp, etc. All that is required is for there to be enough space to display the SQR code.

The ability of a mobile device to use its camera as a QR code scanner is built into most modern mobile devices with no particular action required by the user other than to point the device's camera to the SQR code.

The end user device decodes 505 the URL value encoded within the SQR code. Once the code is recognized, a pop-up appears on the screen which the user can then select and an action is taken based on the data provided by the SQR code which is automatically decoded by a part of the mobile device's operating system designed for this task.

The end-user device launches 507 the API client. The API client can be a Web App (browser) or a native app. Typically, the decoded URL directs a browser app on the mobile device to access the web page pointed to by the URL. It could also be a native app running on the mobile device in which case the app is launched and the information provided by the API client is sent to this app. The information, whether provided whether to the accessed web page or launched app, is as follows: [protocol]://[address].

The API client generates 511 a unique identifier (UUID) for the device and sends a request to the backend to register it. The UUID is generated by the API client via background process running in the background on the native app (including web browser) which retrieves the device parameters made available by the operating system (including OS name, OS version, device model, locale, as well machine learning to generate a value (hash code) that can uniquely identify a device with a 99.5% accuracy. The generated UUID for all practical purposes is unique in that it is randomly generated from a large enough set of possibilities as to make it effectively unique even though a duplicate is theoretically possible. Since the API client generates the UUID, its use and uniqueness only applies to processes accessed by the API client. At this time, the location of the device is also sent using the latitude/longitude values provided by the GPS of the device where the API client is installed. The location is also stored as part of the device record. That is, at the time of scanning the SQR code, the backend server is also provided with the location of the device which can be used to determine the content to be delivered. This is another way in which the same SQR code can provide different results based on location The backend server also takes into account the date and time when the request is made and uses them as factors when determining what content to deliver as a response. The date and time is determined by the server at the time of the request by creating a timestamp in UTC (Universal Time Coordinated) format which is also stored as part of the device record.

The backend server stores 513 the device record using the UUID provided. The UUID is used by the backend server as described below with reference to FIG. 6 to track the user device which generated it. The tracked information includes, by way of example requests for content delivery, the interactions with the content piece, including, view, save to native wallet, redemption (in-store and/or online), declines, etc.

Although the API client already has the trigger ID from the QR code, it is not used until the end user device is registered with the backend server. In this manner, it can be ensured that each request from each end user device is separately tracked and handled

The API client retrieves 515 the trigger ID from the URL (decoded value). As noted above, the trigger ID is typically a URL encoded in the QR code. The trigger ID is retrieved from the URL obtained from the scanned QR code as follows. The native app or web browser looks for the key/value pair “trigger_id=[value]” within the decoded string, and stores the value in its local cache so that it can be used when requesting content from the backend server.

The API client requests 517 the delivery of offers providing the trigger ID and device UUID as part of the request. At this point, the trigger ID/URL is sent to the backend server.

The backend server retrieves the trigger configuration, including the content sequence, and based on targeting and sequence parameters and determines 519 which content item to send back to the API client. This is the information set up by the admin user as described above with reference to FIG. 4 which is sent back to the API client.

The API client renders 521 the offer view as a user interface which lets the user interact with the offer. All interactions are stored (tracked) 523 in the back end as “impressions.”

By way of example, when an offer is delivered to the API client, a “delivered” impression is recorded; when the API client successfully displays the offer to the end-user, a “view” impression is recorded: when the user taps on the “save offer” button, a “save” impression is recorded; when the end-user taps on the “Redeem Online” button, a “redeem-online” impression is recorded; when the end-user taps on the “Redeem In-Store” button, a “redeem-in-store” impression is recorded; when the end-user taps on “No, thanks” (not interested in such offer), a “decline” impression is recorded; when the end-user taps on the “Delete” button, a “delete” impression is recorded; when the offer is successfully redeemed (it has been applied during the purchase of an item), a “complete” impression is recorded.

If the end user decides to “Save to Wallet” 525, the API client sends a request to the backend server 303 to generate 526 a native wallet pass object. A native wallet pass object is an encrypted string (text value) that contains all the offer details in a format that can be securely transmitted to the native wallet applications. The API client provides the wallet object to the end-user device 310 and the device handles the insertion 529 of the offer into the native wallet. Depending on the native wallet capabilities, reminders 531 can be sent to the user to redeem the offer. Using the expiration date of the offer, the native wallets automatically remind users to redeem the offer as the expiration date approaches. Alternatively, using the points of interest associated with the brand that have been set to the offer, the backend inserts location information (lat/lon coordinates) as part of the native pass. The native wallets use this location information as the basis to trigger reminders when the user is in proximity to a point of interest.

If the end user decides to “Buy Online” 527, the end-user device launches 533 an e-commerce site for the user to complete the purchase. At this point, processing proceeds as in the prior art which enables a user to access an e-commerce site and make a purchase.

If the user decides to “Buy In-Store” 535, the API client displays a redemption code for 537 the user to show to the retail store and redeem 539 where the item is being purchased.

As noted above, the end-user can scan the SQR code again and repeat the process. Since the backend server is able to track new requests from a device based on its UUID, the content which is determined to be delivered by the backend server can be different than the prior content obtained by any prior scan. In this manner, although a static QR code is scanned, the UUID enables the backend server to provide the same advantages as would be obtained by using a dynamic QR code.

FIG. 6 provides a detailed view of the main process that happens on the backend server while delivering offers in a sequential manner. FIG. 6 is a more detailed view of the process shown in FIG. 3.

API client 305 generates 601 a device UUID and retrieves 603 the trigger ID from the URL decoded from the SQR code as described with reference to FIG. 3. Using the Device UUID and trigger ID, the API requests 605 the delivery of content (offers) from the backend server.

The backend server 303 retrieves 609 the device UUID from the header of the request. A typical request with its header looks like this:

### Request Header

:authority: api.actv8technologies.com
:method: POST
:path:/qrcode/422/catch?client_id=1
:scheme: https
accept: application/json, text/plain, */*
accept-encoding: gzip, deflate, br
accept-language: en-US,en;q=0.9
cache-control: no-cache
content-length: 2
content-type: application/json;charset=UTF-8
origin: https://catch.actv8technologies.com
pragma: no-cache
referer: https://catch.actv8technologies.com/
sec-fetch-dest: empty
sec-fetch-mode: cors
sec-fetch-site: same-site
user-agent: Mozilla/5.0 (iPhone; CPU iPhone OS 13_2_3 like Mac OS X) Apple WebKit/605.1.15 (KHTML, like Gecko) Version/13.0.3 Mobile/15E148 Safari/604.1
x-api-key: 2376f984b8ccea1b0ef212797e3e3f21fa4024d7
x-api-version: 4.4
x-device-uuid: SZLzKtEPDsgBcJx9LwKL

### Request URL

https://api.actv8technologies.com/qrcode/422/catch?client_id=1

The specifics of the Request Header and Request URL are not important for an understanding of the invention-that is, the manner in which this type of information is generated and used is well known to persons having ordinary skill in the art.

The backend server then retrieves 613 the trigger ID from the body of the request and uses the trigger ID to retrieve 615 the trigger configuration from the database. The retrieved trigger configuration is used to retrieve 617 the content delivery rules. The server software then loops 621 through the configured content and creates a curated list that contains only the content that matches defined target parameters. These include: location (city, state, country), locale (e.g., Southern California, etc.), language (e.g., “English”, “Spanish”, etc.), date/time, operating system, manufacturer (i.e. Apple®, Samsung®, Google®, etc.). The server software then picks 623 the first content item from the curated list.

Using the device UUID, the server software determines 625 if the content item has already been delivered to that device: If it has already been delivered, the next content item 627 in the curated list is selected. This process repeats until a content item is found that has not been delivered. If none exists, no content is returned (HTTP 204—empty response)

If the content has not yet been delivered, it is then delivered 631 to the API client as a HTTP 200 (success) response. The API client then renders 633 the offer view for the user to interact with. An image 639 of the product may be displayed along with a redeem button and a save to wallet 643 button.

In an embodiment, backend server 303 is configured to keep track of the number of times a particular QR code is scanned by the same user, for example by the device UUID. Although as noted above, using the device UUID, the server software determines 625 if the content item has already been delivered to that device in which case the next content item 627 in the curated list is selected, if a particular QR code is subsequently scanned by a user, by keeping track of the number of times the user scanned that particular QR code, a mesh can be created so that different content is provided based on the number of times that particular QR code or a related product with another QR is scanned by a user. By way of example, if a product from a particular manufacturer has one QR code, other products from that particular manufacturer with a different QR code can be connected by the backend server so that the user experience is a function of how many times the QR code from products from a single manufacturer was scanned by a particular user. Of course, such a mesh can be created based on any desired criteria such as QR codes on products which relate to a particular field such as sports related, travel related, food related, art related and so on. By keeping track of the types products or services and number for times their QR codes were scanned by a user, a very targeted user experience can be created.

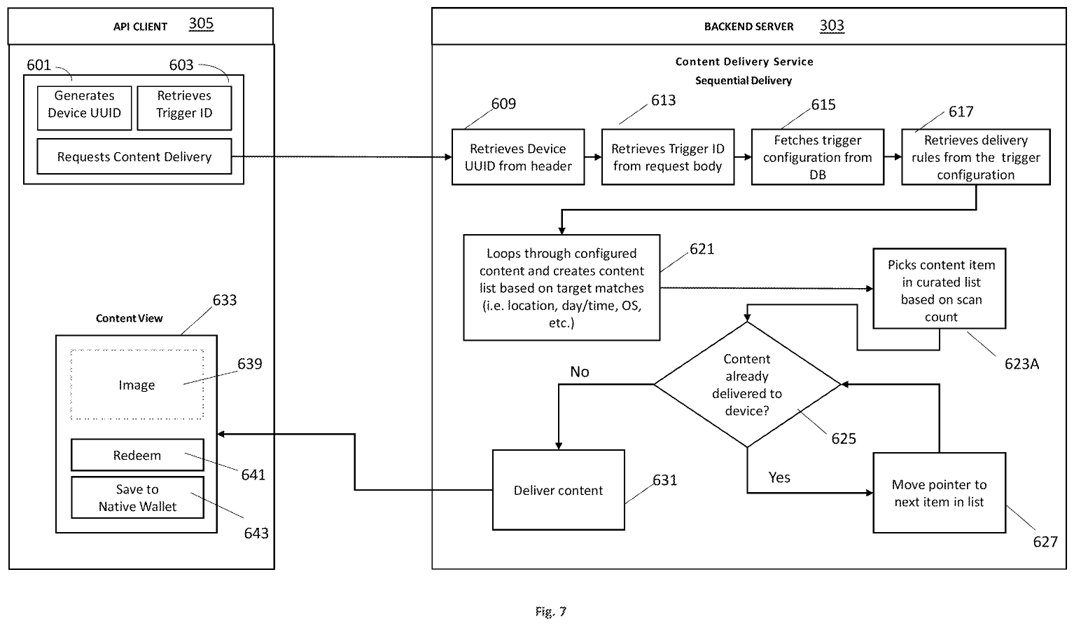

FIG. 7 illustrates this embodiment. FIG. 7 is the same as FIG. 6 except instead of block 623 picking the first content item from the curated list, block 623A picks the content item based on the number of times a particular or related QR code was scanned by the same user.

In this manner, by using a static QR code which only contains a URL or app to be launched, and providing an API client and backend server as described herein, different content can be provided based on a variety of parameters as described herein.

The invention is implemented as a system and method using the various hardware elements described above with appropriate programming of the sequential configuration, trigger settings, backend server, and API client to provide the described functionality. Each of these elements uses a processor, storage and programming to supplement the generic functionality of these devices to produce functionality not currently available. The specifics of the processors and storage elements utilized are well known to persons skilled in the art, and such details are not needed for a full understanding of the invention. However, providing SQR code functionality on a mobile or other device which operates in conjunction with triggering mechanisms based on desired sequential configurations provides marketing and other advantages not currently available using prior art techniques.

Although the invention has been described using various examples and detailed descriptions, the invention is not intended to be limited by the specific examples and descriptions provided, but rather is limited only by the following claims.

I claim:

1. A method for delivery of content triggered after scanning a sequential QR code with a device comprising:
a) retrieving a UUID from the device based on a request received from the device;
b) retrieving a trigger ID from the device based on the request received from the device;
c) fetching a previously created trigger configuration;
d) obtaining a delivery setting from the fetched trigger configuration;
e) creating a content list based prior scans by said device of said sequential QR code or a related sequential QR code;
e) selecting a content item from said content list based on a count of said prior scans;
f) delivering said selected content item to said device for display on said device and updating a count of prior scans by said device of said sequential QR code or a related sequential QR code.

2. The method defined by claim 1 wherein said UUID comprises a hash code generated by said device using parameters including OS name, OS version, device model, and locale.

3. The method defined by claim 1 wherein said trigger ID is a URL.

4. The method defined by claim 1 further comprising retrieving location information from the device and storing a timestamp when the request is received.

5. A method for obtaining content for use by a device from a server comprising:
(a) sending to said server a UUID, and a URL for said server to store a device record for said device;
(b) retrieving a trigger ID from said URL;
(c) requesting content from said server by sending said trigger ID to said server;
(d) receiving said content from said server and rendering said content on a display of said device;
d) obtaining a delivery setting from the fetched trigger configuration;
e) creating a content list based on prior scans by said device of said sequential QR code or a related sequential QR code;
e) selecting a content item from said content list;
f) delivering said selected content item to said device for display on said device and updating a count of prior scans by said device of said sequential QR code or a related sequential QR code.

6. The method defined by claim 5 further comprising sending to said server location information of said device for said server to store in said device record.

7. A system for delivery of content triggered after scanning a sequential QR code with a device comprising:
a) a server configured to retrieve a UUID from the device based on a request received from the device;
b) the server configured to retrieve a trigger ID from the device based on the request received from the device;
c) the server configured to fetch a previously created trigger configuration;
d) the server configured to obtain a delivery setting from the fetched trigger configuration;
e) the server configured to create a content list based prior scans by said device of said sequential QR code or a related sequential QR code;
e) selecting a content item from said content list;
f) delivering said selected content item to said device for display on said device and updating a count of prior scans by said device of said sequential QR code or a related sequential QR code.
g) the device including an API configured to send to said server a UUID, and a URL for said server to store said device record for said device;
(h) the API configured to retrieve said trigger ID from said URL;
(i) the API configured to retrieve content from said server by sending said trigger ID to said server;
(j) the API configured to receive said content from said server and render said content on a display of said device;
(k) based on a user selection using said rendered content being displayed, the API configured to select one of storing said user selection in a digital wallet of said device, launching an e-commerce site based on said user selection, and creating a reminder for said user to take further action based on said rendered content at a later time.
